(19) United States
(12) Patent Application Publication
(10) Pub. No.: US 2018/0298988 A1
(43) Pub. Date: Oct. 18, 2018

(54) SPEED ADJUSTABLE RETURNING APPARATUS FOR ELECTRIC ACTUATOR

(71) Applicant: Flowinn (Shanghai) Industrial Co., Ltd., Shanghai (CN)

(72) Inventor: KUO-FENG HSU, Shanghai (CN)

(21) Appl. No.: 15/489,739

(22) Filed: Apr. 18, 2017

(51) Int. Cl. F16H 3/10; H02K 7/108; H02K 7/116; F16D 11/14; F16K 17/36

(52) U.S. Cl. CPC F16H 3/10; H02K 7/108; F16D 2300/14; F16D 11/14; F16K 17/36; H02K 7/116

(57) ABSTRACT

A speed adjustable returning apparatus for an electric actuator utilizes a cooperative configuration between the one-way driving device and the clutch device during the use of the apparatus in order to prevent damages caused by the operating unit driven by the opening/closing assembly. In addition, the clutch device is able to allow the operating device to selectively drive the opening/closing assembly in order to prevent impacts on the opening/closing assembly due to accidental movements of the operating device. Consequently, the present invention is able to achieve the effect of preventing damages of relevant equipment and providing a safer uses for applications.

### (a) TECHNICAL FIELD OF THE INVENTION

The present invention is related to a speed adjustable returning apparatus for an electric actuator, capable of preventing damages of relevant equipment and providing greater safety of use thereof.

### (b) DESCRIPTION OF THE PRIOR ART

Currently, the most common restoring component used in the market is a known spring restoring device utilizing the concept of mechanical energy storage to control the automatic closing and opening of valves. The main features of such known spring restoring device rely in that during the normal power supply, the motor is actuated to generate spring deformation of the spring restoring device in order to store energy, and under the condition where power is insufficient during such as power outage, the spring is able to restore from the deformation by releasing the stored energy in order to drive the valve to return back to the normal state (such as completely closed or completely opened) automatically. However, since the speed of such returning process is fast (approximately 2˜3 seconds only), it is extremely likely to cause a huge instant difference in the flow, leading to explosion of pipe (also known as the water-hammer effect) and damages of the pipe.

In addition, despite there are some returning components known to have installed with manual devices, such as hand wheels etc., nonetheless, the manual device tends to rotation on its own along with the opening or closing of the valve. As a result, there is potential risk of damages caused by the self-rotation of the manual device in collision with the surrounding objects; and similarly, when the manual device is accidentally moved, it also tends to drive the valve, leading to damages of the device as well.

### SUMMARY OF THE INVENTION

An objective of the present invention is to increase the safety of use and reduce the possibility of the damage of an electric actuator.

To achieve the aforementioned objective, the present invention provides a speed adjustable returning apparatus for an electric actuator, having an opening/closing assembly and an operating device arranged on one side of the opening/closing assembly and connected thereto for actuation, and the operating device comprises at least one transmission axle set arranged at one side of the operating device adjacent to the opening/closing assembly and configured to connect to the opening/closing assembly for actuation together; at least one operating unit arranged at one side of the transmission axle set away from the opening/closing assembly; at least one clutch device arranged between the operating unit and the transmission axle set and configured to allow the operating unit to selectively drive the transmission axle; and at least one one-way driving device arranged between the transmission axle set and the clutch device and configured to selectively control the transmission axle set to drive the clutch device.

Accordingly, when the opening/closing assembly is actuated, the transmission axle set is driven to operation; however, with the cooperative configuration of the one-way driving device and the clutch device, the operating unit is prohibited from being driven by the transmission axle set but remains stationary in order to prevent damages on the surrounding due to the rotation of the operating unit; therefore, the safety of the device is improved. In addition, in the event where the operating unit is accidentally moved, since the clutch device is able to prohibit the operating unit from directly driving the transmission axle set and the opening/closing assembly, it is able to reduce the possibility of damaging the opening/closing assembly due to abnormal transmission of the transmission axle set caused by accidental actions on the operating unit. Based on the aforementioned technique, the drawback of damages on the surrounding due to self-rotations of the manual device associated with the known spring returning device can be overcome, and the issue of the damages caused by abnormal actuation due to collision on the manual device can be solved in order to achieve the advantageous effects of preventing damages of relevant equipment and making the application of the user relatively safer.

### BRIEF DESCRIPTION OF DRAWING

FIG. 1 is a schematic view showing an embodiment of the apparatus present invention;

FIG. 2 is a schematic view showing a structure of the apparatus of the present invention;

FIG. 3 is a schematic view showing a state of energy storage of the apparatus of the present invention;

FIG. 4 is a schematic view showing a state of energy release of the apparatus of the present invention;

FIG. 5 is a schematic view showing an operating state of the apparatus of the present invention;

FIG. 6 is a schematic view showing an positioning state of the apparatus of the present invention; and

FIG. 7 is a schematic view showing a regulating state of the apparatus of the present invention.

### DETAILED DESCRIPTION OF THE INVENTION

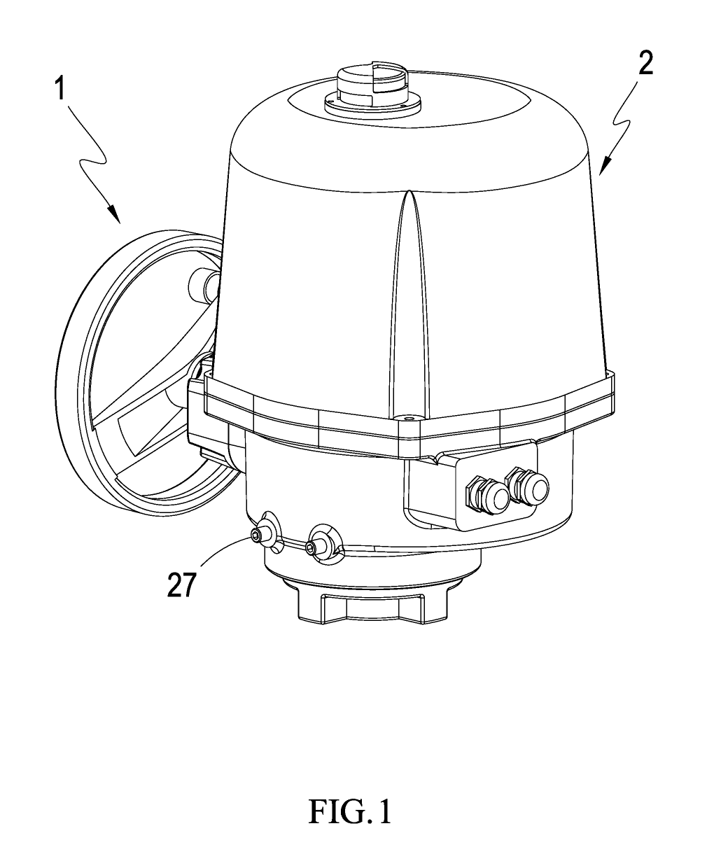

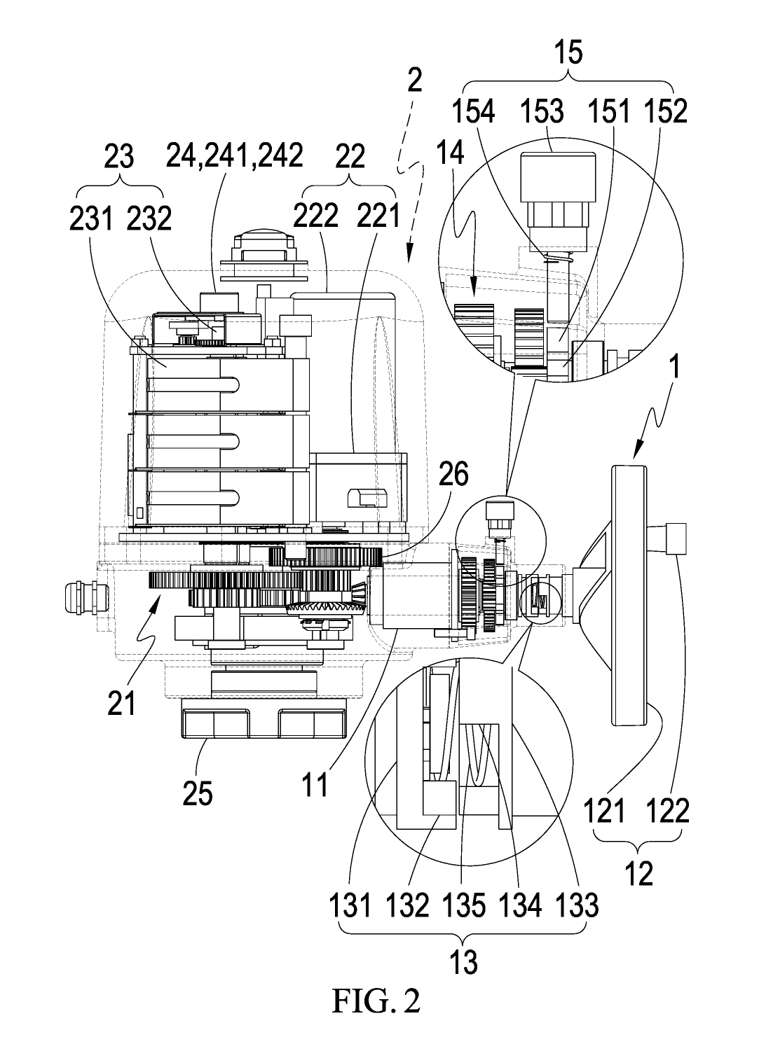

As shown in FIG. 1 and FIG. 2, a speed adjustable returning apparatus for an electric actuator of the present invention comprises an opening/closing assembly 2 and an operating device 1 arranged on one side of the opening/closing assembly 2 and connected thereto for actuation.

The operating device 1 comprises at least one transmission axle set, at least one operating unit 12, at least one clutch device 13, at least one one-way driving device 14 and at least one positioning device 15. The transmission axle set 11 is arranged at one side of the operating device 1 adjacent to the opening/closing assembly 2 and is configured to connect to the opening/closing assembly 2 for actuation. The operating unit 12 is arranged at one side of the transmission assembly set away from opening/closing assembly 2. The operating unit 12 comprises a transmission member 121 and at least one auxiliary member 122 arranged on the transmission member 121. In this embodiment, the rotating member 121 is a hand wheel, and the auxiliary member 122 is a rotating handle as an example of the embodiment.

The clutch device 13 is arranged between the operating unit 12 and the transmission axle set 11. In addition, the clutch device 13 comprises a first clutch member 131 arranged at one side of the operating unit 12, a second clutch member 133 arranged at one side of the one-way driving device 14 and at least one clutch elastic member 135 arranged between the first clutch member 131 and the second clutch member 133. The clutch elastic member 135 is configured to selectively disengage from the first clutch member 131 and the second clutch member 133. In addition, an end portion of the first clutch member 131 adjacent to the second clutch member 133 includes at least one first engagement portion 132, and an end portion of the second clutch member 133 adjacent to the first clutch member 131 includes at least one second engagement portion 134 having a shape corresponding to a shape of the first engagement portion 132 in order to allow the operating unit 12 to selectively drive the transmission axle 11.

The one-way driving device 14 is arranged between the transmission axle set 11 and the clutch device 13 in order to selectively control the transmission axle set 11 to drive the clutch device 13. In this embodiment, the one-way driving device 14 comprises any one of a gear and a ratchet.

The positioning device 15 is arranged between the clutch device 13 and the one-way driving device 14. In addition, the positioning device 15 comprises at least one follower 151 connected to the clutch device 13 and the one-way driving device 14, at least one positioning rod 153 arranged at one side of the follower 151 and at least one positioning elastic member 154 arranged at one side of the positioning rod 153. Furthermore, the follower 151 includes a plurality of positioning slots 152 formed thereon and provided for the positioning rods 153 to be selectively inserted therein for positioning.

The opening/closing assembly 2 comprises at least one kinetic energy transmission device 21 arranged at one side of the transmission axle set 11 and connected thereto for actuation, at least one power driving device 22 arranged at one side of the kinetic energy transmission device 21 and connected thereto for actuation, at least one returning device 23 arranged at one side of the kinetic energy transmission device 21 and connected thereto for actuation, at least one speed adjusting device 24 arranged at one side of the returning device 23 and connected thereto for actuation and at least one opening/closing device 25 arranged at one side of the kinetic energy transmission device 21 and connected thereto for actuation. In this embodiment, the kinetic energy transmission device 21 is a planetary gear set and the opening/closing device 25 is an opening/closing valve as examples of the embodiment. Moreover, the valve further includes a regulating device 27 installed at one side thereof and used for controlling an opening/closing angle of the opening/closing device 25.

The power driving device 22 comprises a speed reduction mechanism 221 connected to the kinetic energy transmission device 21 and a motor 222 connected to a side of the speed reduction mechanism 221. In addition, an least one one-way transmission device 26 is installed between the speed reduction mechanism 221 and the kinetic energy transmission device 21. The returning device 23 comprises at least one energy storage units 231 and at least one securement device 232 arranged at one side of each one of the at least one energy storage units 231. In this embodiment, the energy storage unit 231 is an elastic coil as an example of the embodiment. The speed adjusting device 24 comprises at least one power generation device 241 connected to the returning device 23 for actuation and at least one damping device 242 arranged at one side of the power generation device 241 and connected to the returning device 23 for actuation. Furthermore, it can be understood that the aforementioned structure refers to an exemplary embodiment of the present invention only, and the present invention is not limited to such type only.

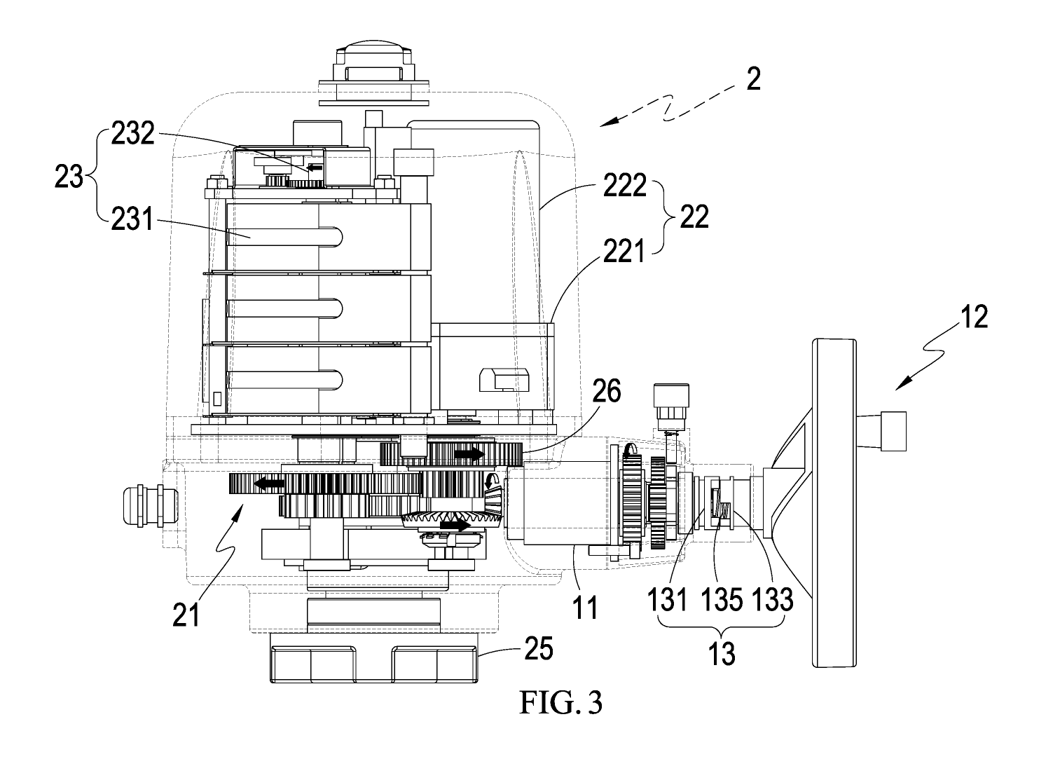

As shown in FIG. 1 to FIG. 7, in particular FIG. 3, during the normal actuation of the apparatus of the present invention, the opening/closing assembly 2 receives the electric power normally for actuation, and the motor 222 of the power driving device 22 generates the driving power and transmits it to the speed reduction mechanism 221. The torque of the driving power is increased by the speed reduction mechanism 221, which is then further transmitted to the kinetic energy transmission device 21 via the one-way transmission device 26. The kinetic transmission device 21 then drives the returning device 23 and the opening/closing device 25 such that the energy storage unit 231 is able to perform deformation for storing energy. Once energy is stored to a certain level, the securement device 232 automatically secures the energy storage unit 231. In addition, the opening/closing device 25 is driven by the kinetic energy transmission device 21 to change its opened/closed state. In this embodiment, the opening/closing device 25 is normally under a closed state, and it is at an opened state during the actuation, as an example of the embodiment. Accordingly, the opening/closing device 25 is able to change from the closed state to the opened state in order to allow the fluid to flow through for subsequent uses. On the other hand, in another embodiment of the present invention, the opening/closing device 25 can also be under an opened state normally and under a closed state during actuation.

Furthermore, since the clutch elastic member 135 of the clutch device 13 is able to keep the second clutch member 133 and the first clutch member 131 disengage from each other without relative movements, the operating unit 12 is prohibited from rotating along with the kinetic energy transmission device 21; therefore, it is able to prevent damages of the surrounding by the operating unit 12. In addition, since the clutch elastic member 135 of the clutch device 13 is able to keep the first clutch member 131 and the second clutch member 133 disengage from each other without relative movements, any accidental movements of the operating unit 12 would not drive the transmission axle set 11 and the kinetic transmission device 21 to move; consequently, damages due to interactions during actuation can be prevented.

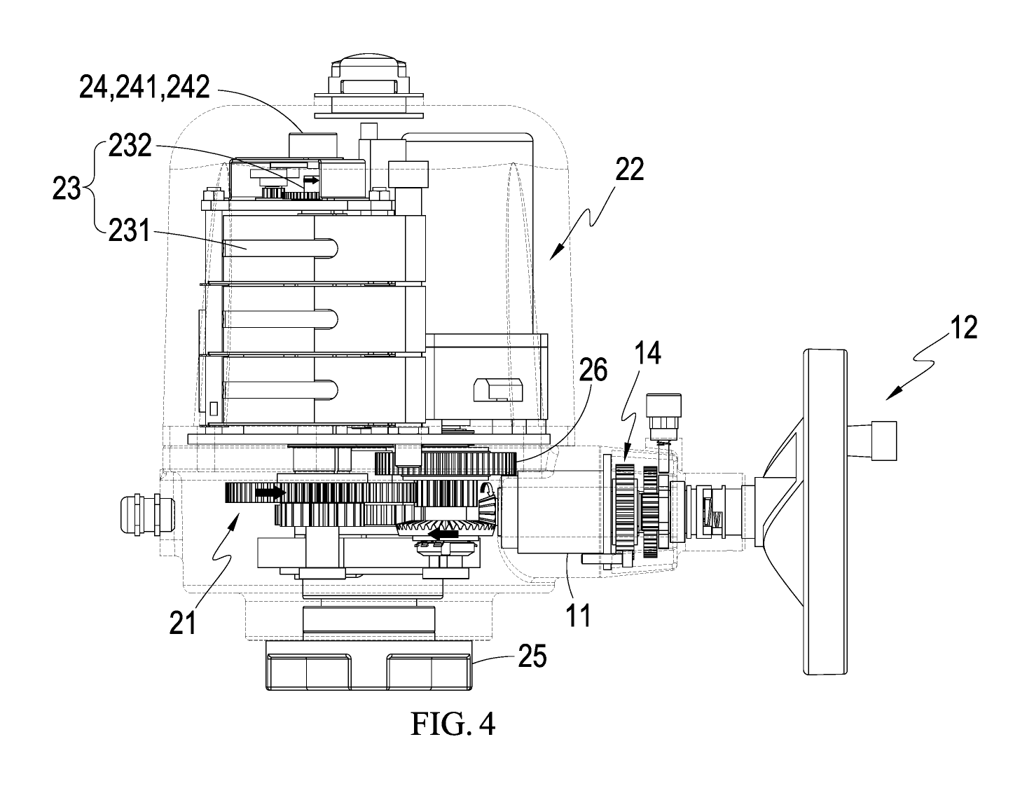

Please refer to FIG. 4. During the occurrence of power outage, the securement device 232 is able to release the energy storage unit 231, and the energy storage unit 231 then releases its energy through the transmission device 21 to allow the opening/closing device 25 to change from the opened state to the closed state automatically without the use of the electrical power. In addition, the energy storage unit 231 is able to drive the power generation device 241 of the speed adjusting device 24 to actuate, the power generation device 241 transmits the electric power to the damping device 242, and the damping device 242 then actuates the returning device 23 to generate a resistance in order to reduce the energy releasing speed of the energy storage unit 231; in other words, the time required for the opening/closing device 25 to change the opened/closed state is prolonged such that the opening/closing device 25 is able to perform closing without the use of electrical power and to further prevent damages caused by the pipe explosion (also known as the water-hammer effect). Moreover, since the one-way transmission device 26 is of the characteristic of one-way transmission, after the one-way transmission device 26 is driven by the kinetic energy transmission device 21, it performs idle runs such that damages caused by the actuation of the power driving device 22 can be prevented. Furthermore, the one-way driving device 14 is also of the characteristic of one-way transmission; therefore, after the one-way driving device 14 is driven by the kinetic energy transmission device via the transmission axle set 11, it is able to perform idle runs such that damages to the surrounding caused by the actuation of the operating unit 12 can be prevented.

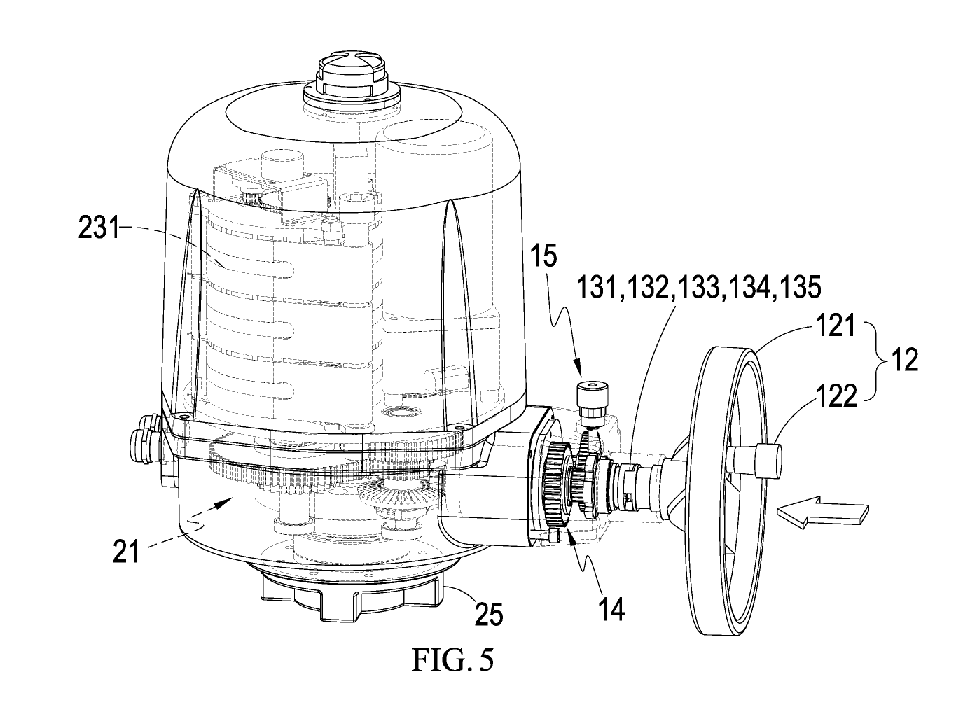

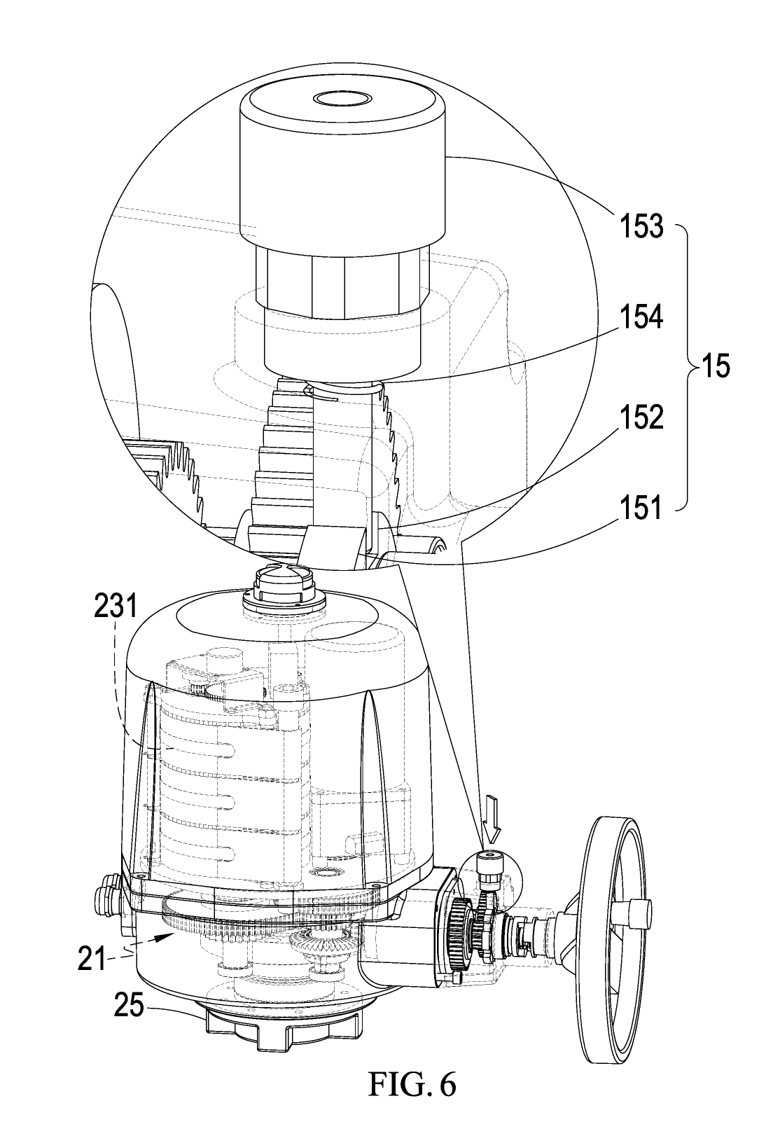

Please refer to FIG. 5. During the occurrence of the power outage and when manual method is desired to operate opening/closing device 25, the user can hold the operating unit 12 (rotating member 121 or auxiliary member 122) first and pushes the unit to compress the clutch elastic member 135 in order to allow the first clutch member 131 and the second clutch member 133 to engage with each other. Next, the operating unit 12 can be rotated to allow the first engagement portion 132 to correspondingly abut against the second engagement portion 134 in order to transmit the driving power to the kinetic transmission device 21 via the positioning device 14 and the one-way driving device 14 such that the opening/closing device 25 is driven to an opened state while allowing the energy storage unit 231 to store energy at the same time. When no operation is required, the user can simply release the operating unit 12, and the clutch elastic member 135 can then allow the first clutch member 131 and the second clutch member 133 to return to the disengaged state. Please refer to FIG. 6, in the event where there is a need to temporarily maintain the opening/closing device 25 at the opened state, then the user can operate the positioning rod 153 of the positioning device 15 in order to allow the positioning rod 153 to move and to compress the positioning elastic member 154 to store energy, followed by inserting into the positioning slot 153 for securing the follower 151. At this time, the energy storage unit 231 is able to release energy to the follower 151 via the kinetic energy transmission device 21 in order to allow the positioning rod 153 to contact with the side wall of the positioning slot 152 and to generate friction therebetween. Since the friction is greater than the energy stored by the positioning elastic member 154, it is able to maintain the follower 151 to be positioned inside the positioning slot 152 and to secure the follower 151. Furthermore, when electrical power is supplied again, the follower 151 then loses the energy such that the positioning elastic member 154 is able to push the positioning rod 153 to disengage from the positioning slot 152 such that the effect of releasing the secured follower 151 is achieved.

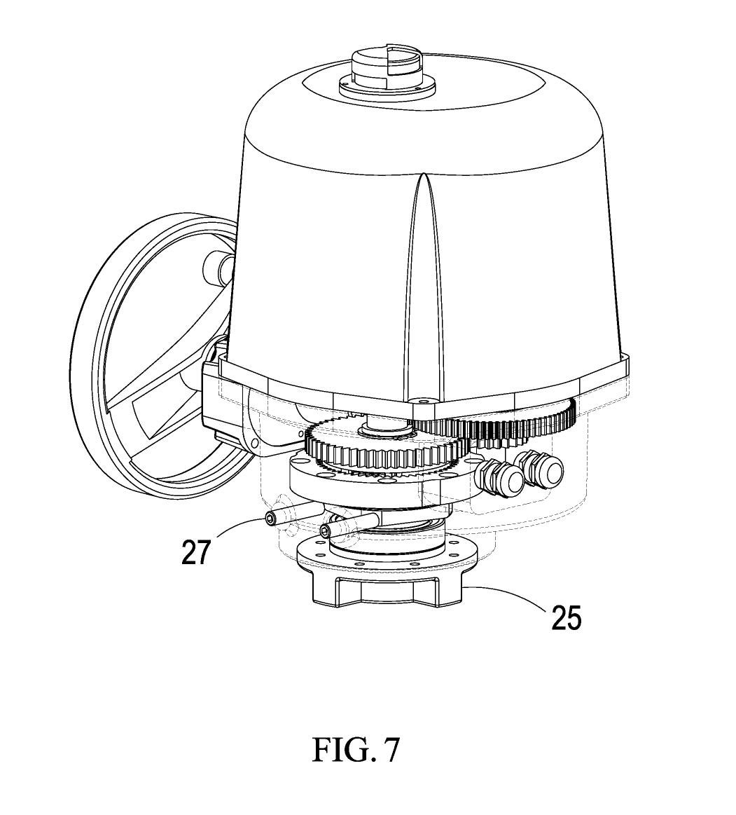

As shown in FIG. 7, the regulating device 27 can be operated to restrict the rotating angle of the opening/closing device 25 in order to control the size of the opening/closing of the opening/closing device 25 and the fluid flow.

I claim:

1. A speed adjustable returning apparatus for an electric actuator, comprising an opening/closing assembly and an operating device arranged on one side of the opening/closing assembly and connected thereto for actuation, and the operating device comprising:
at least one transmission axle set arranged at one side of the operating device adjacent to the opening/closing assembly and configured to connect to the opening/closing assembly for actuation;
at least one operating unit arranged at one side of the transmission axle set away from the opening/closing assembly;
at least one clutch device arranged between the operating unit and the transmission axle set in order to allow the operating unit to selectively drive the transmission axle set; and
at least one one-way driving device arranged between the transmission axle set and the clutch device in order to selectively control the transmission axle set to drive the clutch device.

2. The speed adjustable returning apparatus for an electric actuator according to claim 1, wherein the clutch device comprises a first clutch member arranged at one side of the operating unit, a second clutch member arranged at one side of the one-way driving device and at least one clutch elastic member arranged between the first clutch member and the second clutch member; the clutch elastic member is configured to selectively disengage from the first clutch member and the second clutch member; an end portion of the first clutch adjacent to the second clutch member includes at least one first engagement portion, and an end portion of the second clutch member adjacent to the first clutch member includes at least one second engagement portion having a shape corresponding to a shape of the first engagement portion.

3. The speed adjustable returning apparatus for an electric actuator according to claim 1, wherein the one-way driving device comprises any one of a gear and a ratchet.

4. The speed adjustable returning apparatus for an electric actuator according to claim 1, wherein the operating unit comprises a rotating member and at least one auxiliary member installed on the rotating member.

5. The speed adjustable returning apparatus for an electric actuator according to claim 1, wherein at least one positioning device is arranged between the clutch device and the one-way driving device; the positioning device comprises at least one follower connected to the clutch device and the one-way driving device, at least one positioning rod arranged at one side of the follower and at least one positioning elastic member arranged at one side of the positioning rod; wherein the follower includes a plurality of positioning slots formed thereon and provided for the positioning rods to be selectively inserted therein for positioning.

6. The speed adjustable returning apparatus for an electric actuator according to claim 1, wherein the opening/closing assembly comprises at least one kinetic energy transmission device arranged at one side of the transmission axle set and connected thereto for actuation, at least one power driving device arranged at one side of the kinetic energy transmission device and connected thereto for actuation, at least one returning device arranged at one side of the kinetic energy transmission device and connected thereto for actuation, at least one speed adjusting device arranged at one side of the returning device and connected thereto for actuation and at least one opening/closing device arranged at one side of the kinetic energy transmission device and connected thereto for actuation.

7. The speed adjustable returning apparatus for an electric actuator according to claim 6, wherein the power driving device comprises a speed reduction mechanism connected to the kinetic energy transmission device and a motor connected to a side of the speed reduction mechanism; wherein at least one one-way transmission device is installed between the speed reduction mechanism and the kinetic energy transmission device.

8. The speed adjustable returning apparatus for an electric actuator according to claim 6, wherein the returning device comprises at least one energy storage units and at least one securement device arranged at one side of each one of the at least one energy storage units.

9. The speed adjustable returning apparatus for an electric actuator according to claim 6, wherein the speed adjusting device comprises at least one power generation device connected to the returning device for actuation and at least one damping device arranged at one side of the power generation device and connected to the returning device for actuation.

10. The speed adjustable returning apparatus for an electric actuator according to claim 6, wherein the opening/closing device includes at least one regulating device installed at one side thereof.
